(19) United States
(12) Patent Application Publication
(10) Pub. No.: US 2021/0184859 A1
(43) Pub. Date: Jun. 17, 2021

(54) VALIDATION AND CERTIFICATION OF DIGITAL ASSETS USING A BLOCKCHAIN

(71) Applicant: CONCERTvdc, Inc., Culver City, CA (US)

(72) Inventors: Adam Wilbrecht, Minneapolis, MN (US); Zachary Gentry, Minneapolis, MN (US); David Starke, Minneapolis, MN (US)

(21) Appl. No.: 17/112,529

(22) Filed: Dec. 4, 2020

Related U.S. Application Data
(60) Provisional application No. 62/948,715, filed on Dec. 16, 2019.

(51) Int. Cl. H04L 9/32; G06Q 50/08

(52) U.S. Cl. CPC H04L 9/3236; H04L 9/3297; H04L 2209/38; G06Q 50/08; H04L 9/3247

(57) ABSTRACT

Systems and methods for validation and certification of digital assets using a blockchain are provided. An example method includes, using a hash function to generate at least one hash of at least one digital asset, the digital asset being associated with a plurality of digital assets, storing the hash to a database, determining that the plurality of digital assets have been digitally certified by an authorized user, in response to the determination, storing a record on the blockchain, the record including the hash of the digital asset associated with the plurality of digital assets, and upon receiving a request to verify authenticity of the digital asset, determining a further hash of the digital asset, and determining whether the hash stored on the blockchain matches the at least one further hash to selectively verify the authenticity of the digital asset.

### CROSS-REFERENCE TO RELATED APPLICATIONS

The present application claims benefit of U.S. provisional application No. 62/948,715 filed on Dec. 16, 2019. The disclosure of the aforementioned application is incorporated herein by reference for all purposes.

### TECHNICAL FIELD

The present disclosure relates generally to digital asset processing and, more particularly, to systems and methods for validation and certification of digital assets using a blockchain.

### BACKGROUND

Licensed professionals, such as architects, construction engineers, and construction inspectors create and certify numerous documents. The documents may include technical drawings, architectural sheets, architectural rendering models, hand-drawn sketches, and so on. During a construction project, there is a need for verification of authenticity and tracking different versions of digital assets. There are technologies utilizing blockchains to store different versions of digital assets and to verify authenticity of digital assets. However, because a construction project may include thousands of documents needed to be certified and verified, keeping the documents on a blockchain can be very expensive.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for validation and certification of digital assets using a blockchain. According to an example embodiment, a method for validation and certification of digital assets using a blockchain may include storing information concerning at least one digital asset to a database. The information can be associated with a plurality of digital assets. The information may include an identifier of the digital asset. The identifier may include a hash of the digital asset. The hash of the digital asset can be generated using a hash function, such as an elliptical curve cryptographic hash function. The method may also include determining that the plurality of digital assets have been digitally certified by an authorized user. The method may also include, in response to the determination, storing a record on the blockchain. The record may include the hash of the digital asset associated with the plurality of digital assets.

The hash function may include a cryptographic hash function associated with the blockchain. The method may also include providing at least one further user with permission rights to read the digital asset. The method may include associating a digital signature and professional credentials of the authorized user with the hash. The method may also include associating a timestamp with the at least one hash.

The method may also include receiving a request to verify authenticity of the digital asset. The method may also include using the hash function to hash the digital asset to generate at least one further hash. The method may also include determining whether the hash stored on the blockchain matches the further hash. The method may also include selectively verifying, based on the determination, the authenticity of the at least one digital asset.

The digital asset can be associated with a further plurality of digital assets. The digital asset can be digitally certified by more than one authorized user. The plurality of the digital assets can be digitally certified by one of the following: a professional architect, a construction engineer, a land surveyor, a landscape architect, a geotechnical engineer, and an interior designer. The digital asset can include one of the following: a building information model, an architectural plan sheet, an architectural sketch, a technical drawing, and a manufacturer cut sheet.

According to another embodiment, a system for validation and certification of digital assets using a blockchain is provided. The system may include at least one processor and a memory storing processor-executable codes, wherein the processor can be configured to implement the operations of the above-mentioned method for validation and certification of digital assets using a blockchain.

According to yet another aspect of the disclosure, there is provided a non-transitory processor-readable medium, which stores processor-readable instructions. When the processor-readable instructions are executed by a processor, they cause the processor to implement the above-mentioned method for validation and certification of digital assets using a blockchain.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a block diagram of an environment, in which systems and methods for validation and certification of digital assets using a blockchain can be implemented, according to some example embodiments.

FIG. 2 shows an example system for validation and certification of digital assets using a blockchain, according to an example embodiment.

FIG. 3 is a flow chart showing a method for validation and certification of digital assets using a blockchain, according to an example embodiment.

FIG. 4-6 show example screens of a graphical user interface of a system for validation and certification of digital assets using a blockchain, according to an example embodiment.

FIG. 7 shows a computing system that can be used to implement a system and a method for validation and certification of digital assets using a blockchain, according to an example embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides methods and systems for validation and certification of digital assets using a blockchain. The proposed systems can facilitate exchange of digital assets related to design and construction of buildings. The digital assets can be exchanged with government authorities, construction trades, and professional agents, as needed to perform the work. The digital assets can be issued and iteratively revised to conform to work changes or in response to changes requested by authorized third parties. Embodiments of the present disclosure can provide a mechanism for certifications for architects, engineers, land surveyors, landscape architects, geotechnical engineers, interior designers, and other professionals. Embodiments of the present disclosure can also provide customers with a mechanism for verification of authenticity of digital assets.

Embodiments of the present disclosure may use cryptographic hash functions to associate digital assets with hashes. Once a collection of the digital assets is digitally certified by an authorized professional, a record including the hashes can be memorized on the blockchain. The digital assets can be then freely distributed because the authenticity and provenance of the digital assets can be discoverable by referencing and comparing blockchain cryptographic hashes of the digital assets stored in a database. Embodiments of the present disclosure may facilitate eliminating the need for recording entire digital assets on the blockchain, and, thereby, reducing costs of blockchain services.

Some embodiments of the present disclosure may allow recipients of digital assets to independently verify the authenticity and version history of the digital assets. Certain embodiments of the present disclosure may provide the recipients with the ability to independently verify when a version of the digital assets was in force. Some embodiments of the present disclosure can facilitate identifying redundant digital assets and determining digital assets that can be deleted from a database storing the digital assets.

Embodiments of the present disclosure may enable professionals to certify collections of digital assets remotely by utilizing a blockchain without any need for the professionals to hash and distribute the digital assets.

Embodiments of the present disclosure may also allow validating authenticity of the digital assets by a third-party document management system. The third-party document management system can query the database to determine whether the digital assets have been superseded.

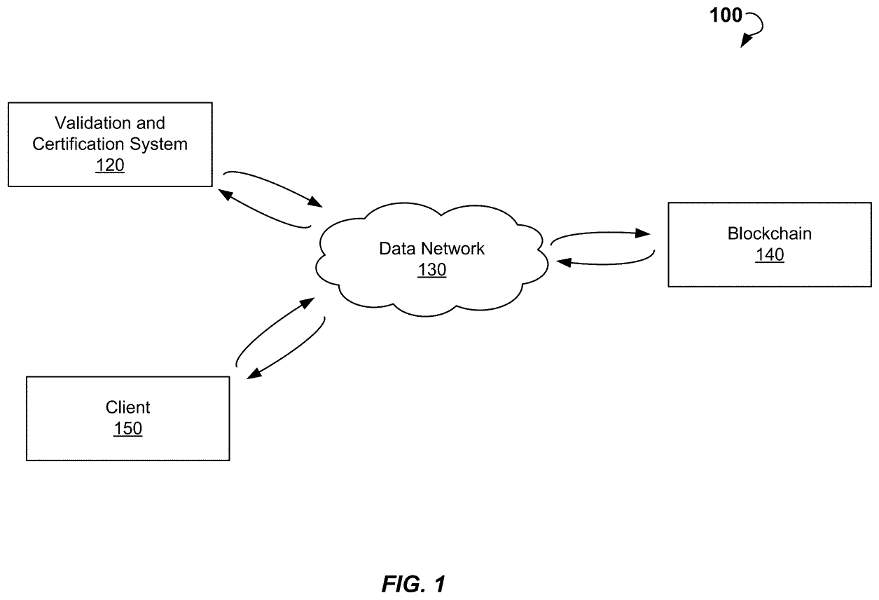

Referring now to the drawings, FIG. 1 is a block diagram of an environment 100, in which systems and methods for validation and certification of digital assets using a blockchain can be implemented, according to some example embodiments. The cloud computing environment 100 may include a verification and certification system 120 (also referred to herein as the system 120 for validation and certification of digital assets using a blockchain), a blockchain 140, and a client 150. The verification and certification system 120, the blockchain 140, and the client 150 can be communicatively connected via a data network 130.

The data network 140 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 140 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

The blockchain 140 may include a combination of application servers and database servers configured to store blocks of records. Each block in the blockchain 140 includes a cryptographic hash of the previous block. The block can also include timestamps and transaction data. Once generated, the block is immutable. A hash of a block on the blockchain can be generated by performing a hash function. Typically, the SHA-256 hashing function is used as the hashing function. The blockchain 140 may be one of public or private blockchains available currently available on the market. The blocks of the blockchain can be distributed between different servers connected via data networks.

The verification and certification system 120 may be implemented as a server or a cloud-based computing system configured to execute one or more applications and to store one or more databases of digital assets. The verification and certification system 120 may store information concerning digital assets to a database. The information may include identifiers of digital assets. The identifiers may include hashes of digital assets. The verification and certification system 120 may generate and store hashes of digital assets to the database. The hashes can be generated using a hash function. Each of the hashes of the digital assets can be associated with one or more collections of digital assets. Optionally, the verification and certification system 120 may store the digital assets to the database. The verification and certification system 120 may track versions of the digital assets.

The verification and certification system 120 may determine that a collection of digital assets have been digitally certified by an authorized user. In response to the determination, the verification and certification system 120 may store a record on the blockchain 140. The record may include hashes of the digital assets in the collection. The verification and certification system 120 may associate the hashes of digital assets with timestamps, digital signatures, and professional credentials of the authorized user who certified the collection.

The client 150 can include a user of a computing device configured to access the applications and databases of the verification and certification system 120. An authorized user can be allowed to download digital assets from the verification and certification system 120. The authorized user may then review and certify a collection of digital assets. The authorized user can include a professional architect, a construction project manager, a construction inspector, and so forth. After the collection of digital assets has been certified by one or more authorized users, the collection can be made available for access by unauthorized users.

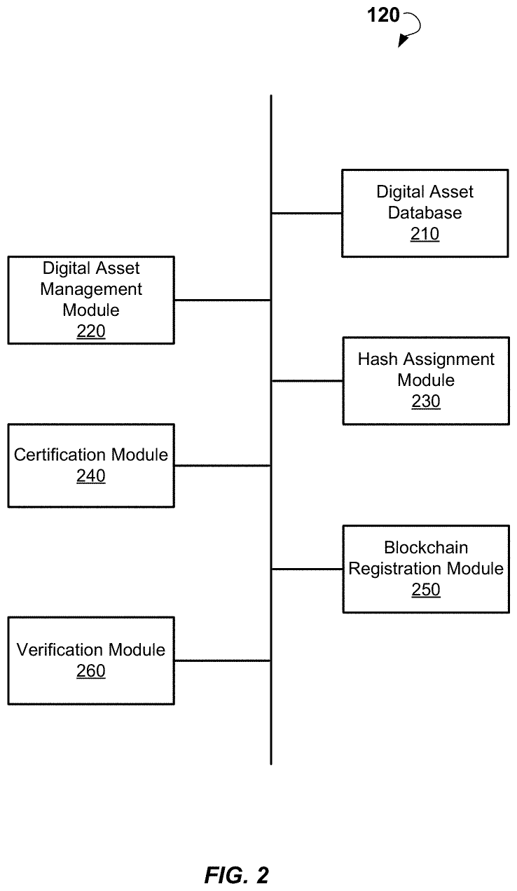

FIG. 2 shows an example system 120 for validation and certification of digital assets using a blockchain, according to an example embodiment. The validation and certification system 120 may include a digital asset database 210, digital asset management module 220, a hash assignment module 230, a certification module 240, a blockchain registration module 250, and a verification module 260.

The digital asset database 210 can be configured to store digital assets. The digital assets may include technical drawings, architectural sheets, architectural rendering models, hand-drawn sketches, and so on. The digital assets may include printable files, for example, Portable Document Format (PDF) files, three dimensional (3D) models, graphical files, video files, audio files, animations, and so forth. Each of the digital assets can be associated with context. The context may include an owner or organization associated with the digital asset, name of at least one collection associated with the digital asset, project name, time the digital asset was uploaded to the database, user that uploaded the digital asset to the database, name of the digital asset, digital signature associated with the digital assets, timestamp of the digital signature, and so on.

The digital asset management module 220 can allow an authorized user to generate a hash of a digital asset and store the hash of the digital asset to the database 210. The digital asset management module 220 can also allow the authorized user to assign the hash of the digital asset to one or more collections, and, thereby, assign the digital asset to the one or more collections. The electronic management module 220 can track versions of the digital asset.

The hash assignment module 230 can generate a hash for the digital asset. The hash can be generated by performing a hash function on the digital asset. Hashing different versions of the digital asset results in different hashes. In other embodiments, additional information (other than hashes) can be used to identify and reference different versions of digital assets. For example, the information may include unique identifiers of digital assets. The unique identifiers can be different for different versions of the digital assets to allow unambiguously referencing the different versions of the digital assets in the database.

The certification module 240 can allow authorized users to digitally certify a collection of digital assets. The certification module 240 may associate the hashes of the digital assets with timestamps. The certification module 240 may associate the hashes of the digital assets with a digital signature and information concerning professional credentials of the authorized users that digitally certified the collection. The information concerning the timestamps, the digital signature and professional credentials of the authorized users can be stored in database 210. The certification module 240 may also change permission attributes of the digital assets in the collection to provide users other than the authorized users with permission rights to read the digital assets.

After the collection of the collection of digital assets is digitally certified, the blockchain registration module 250 can store a record on the blockchain. The record may include hashes of the digital assets belonging to the collection that has been digitally certified. The digital assets are not stored in the blockchain in order to reduce expenses associated with storing blocks on the blockchain.

The verification module 260 can allow users to validate authenticity of a digital asset. The verification module 260 can compute a hash of the digital asset. The verification module 260 may generate a query for the hash on blockchain. The presence of the hash on the blockchain indicates that the digital asset associated with this hash has been previously digitally certified. Then the verification module 260 may retrieve the information associated with the hash from the database 210. The information may include a name of collection to which the digital asset belongs, name and professional credentials of the authorized user who certified the collection, and time the authorized user certified the collection.

The absence of the hash on the blockchain indicates that the digital asset associated with this hash has not been digitally certified. The verification module 260 may also determine whether the hash is stored in the database 210. If the hash is stored in the database 210, the verification module 260 may search for all versions of the digital asset, and display the list of the versions and hashes of the digital asset. The verification module 260 may also determine whether any of the versions of the digital asset were digitally certified and highlight the certified versions. Thus, verification module 260 may allow users to determine whether a version of the digital asset in user possession is new or obsolete.

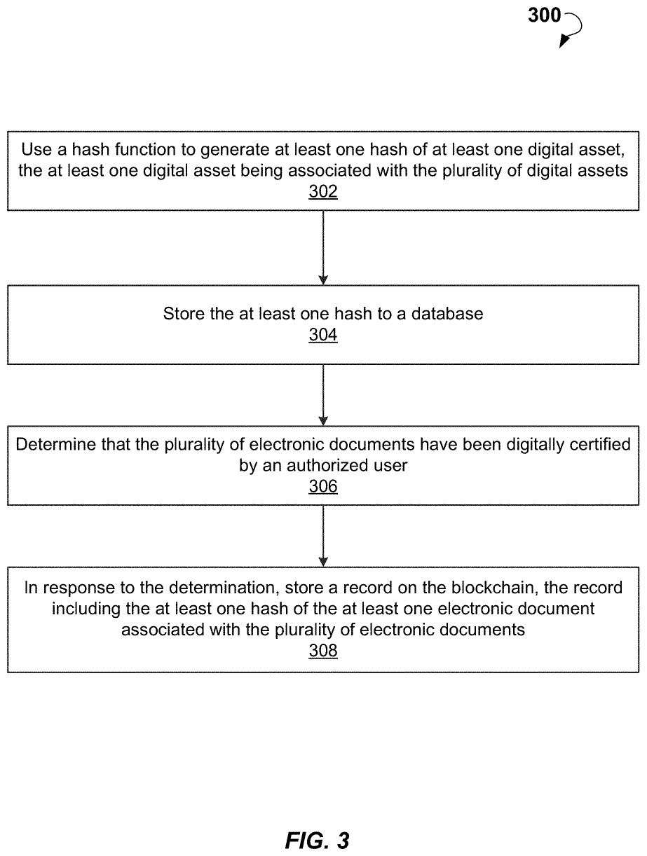

FIG. 3 is a flow chart showing a method for validation and certification of digital assets using a blockchain, according to an example embodiment. The method 300 can be performed by the validation and certification system 120 in environment 100 of FIG. 1.

The method 300 may commence in block 302 with generating at least one hash of at least one digital asset. The hash can be generated using a hash function. The digital asset can be associated with a plurality (a collection) of digital assets The hash function may include a cryptographic hash function. The digital asset can be associated with more than one collection and include one or more of the following: a building information model, architectural plan sheet, architectural sketch, technical drawing, and manufacturer cut sheet.

In block 304, the method 300 may proceed with storing the hash to a database. In block 306, the method 300 may determine that the plurality of digital assets have been digitally certified by an authorized user. The plurality can be digitally certified by one of the following: a professional architect, construction engineer, land surveyor, landscape architect, geotechnical engineer, and interior designer. The digital asset can be digitally certified by more than one authorized user.

In block 306, the method 300 may store a record on the blockchain based on the determination that the plurality of digital assets have been digitally certified by the authorized user. The record may include the hash of the at least one digital asset associated with the plurality of digital assets. The method 300 may further include providing at least one further user with permission rights to read the digital asset. A digital signature and professional credentials of the authorized user can be associated with the hash of the digital asset. A timestamp of the certification can be also associated with the hash of the digital asset.

The method 300 may then proceed with receiving a request to verify authenticity of the digital asset and use the hash function to hash the digital asset to generate at least one further hash. The method 300 may then determine whether the hash stored on the blockchain matches the further hash. The method 300 may then proceed with selectively verifying, based on the determination, the authenticity of the digital asset, and, thereby, verifying that the digital asset has been certified by the authorized user. The hash of the digital asset can be used to retrieve information concerning the authorized user, professional credentials of the authorized user, and time of certification of the digital asset.

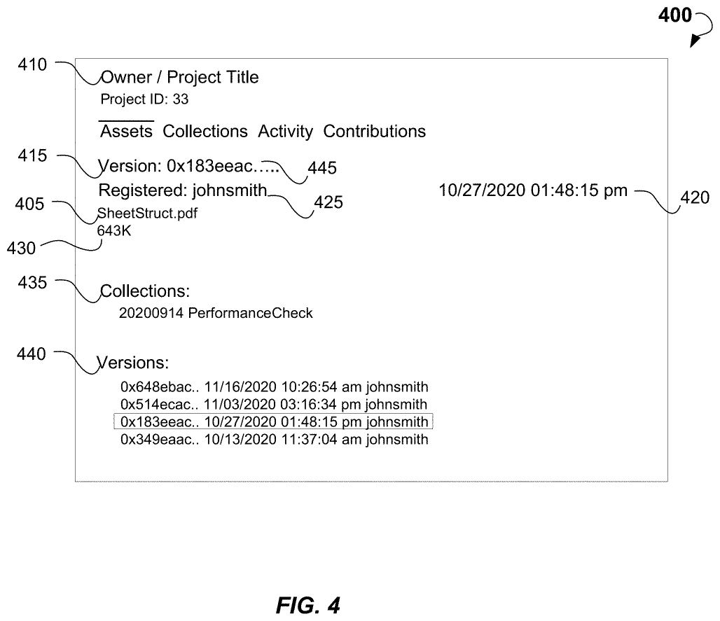

FIG. 4 shows an example screen 400 of a graphical user interface of a system 120 for validation and certification of digital assets using a blockchain, according to an example embodiment. The screen 400 may include results of a request for verification of a digital asset 405. A user may request validation of the digital asset 405 by uploading the digital asset 405 to the system 120. However, the user may not be authorized to modify the digital asset 405.

The system 120 may then calculate the hash 445 of the digital asset 405 and retrieve information associated with the hash 445. The information may include an owner and a project title 410 associated with the digital asset 405. The information may also include a version of the digital asset 415 identified by hash 445, name of an authorized user 425 who uploaded the digital asset 405, time 420 the digital asset was the uploaded by the authorized user and size 430 of the digital asset 415.

The system 120 may then determine, based on the hash 445, to which collections 435 the digital asset 405 belongs. The system 120 may also display a list of versions 440 of the digital asset 405 and highlight the version corresponding to uploaded digital asset 405.

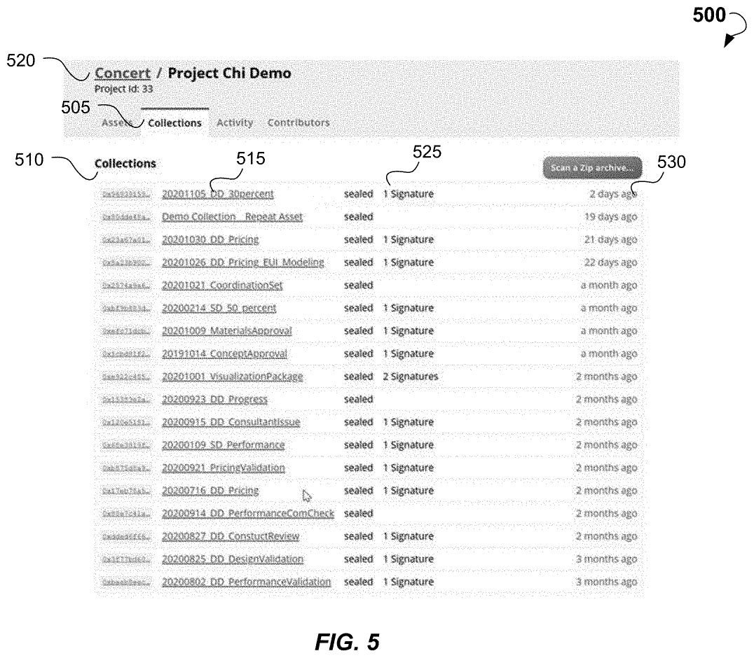

FIG. 5 shows an example screen 500 of a graphical user interface of a system 120 for validation and certification of digital assets using a blockchain, according to an example embodiment. The screen 500 can be accessed by clicking on tab 505 titled “collections”. The screen 500 displays a list of collections 510 associated with the owner and project title 520. The list of collections 510 includes information concerning names 515 of the collections, number of certifications 525 associated with the collections, and timestamps 530 indicating when the collections were certified or sealed to prevent modification.

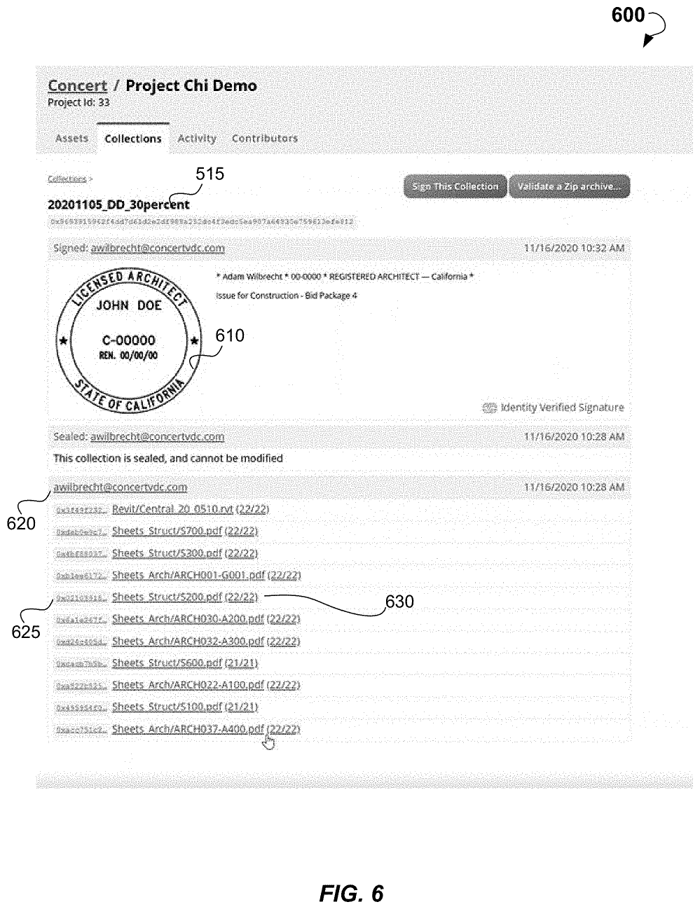

FIG. 6 shows an example screen 600 of a graphical user interface of a system for validation and certification of digital assets using a blockchain, according to an example embodiment. The screen 600 can be accessed by clicking on a name 515 of collection in screen 500. The screen 600 displays a name 515 of collection, information 610 concerning an authorized user who digitally certified the collection, user identifier 620 of the authorized user, and names 630 and hashes 625 of digital assets belonging to the collection 515.

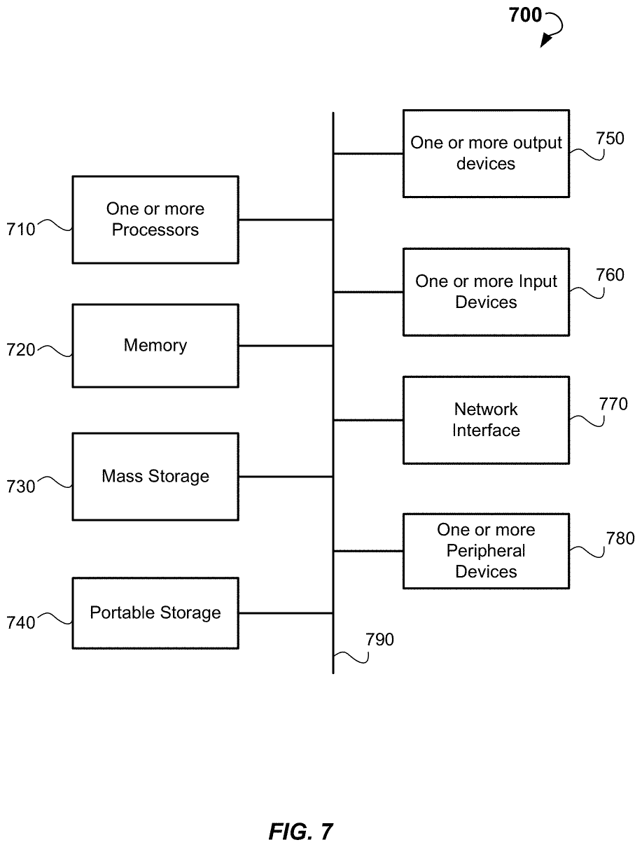

FIG. 7 illustrates an exemplary computing system 700 that may be used to implement embodiments described herein. The computing system 700 can be implemented in the contexts of the validation and certification system 120, the blockchain 140, and the client 150. The exemplary computing system 700 of FIG. 7 may include one or more processors 710 and memory 720. Memory 720 may store, in part, instructions and data for execution by the one or more processors 710. Memory 720 can store the executable code when the exemplary computing system 700 is in operation. The exemplary computing system 700 of FIG. 7 may further include a mass storage 730, portable storage 740, one or more output devices 750, one or more input devices 760, a network interface 770, and one or more peripheral devices 780.

The components shown in FIG. 7 are depicted as being connected via a single bus 790. The components may be connected through one or more data transport means. The one or more processors 710 and memory 720 may be connected via a local microprocessor bus, and the mass storage 730, one or more peripheral devices 780, portable storage 740, and network interface 770 may be connected via one or more input/output buses.

Mass storage 730, which may be implemented with a magnetic disk drive or an optical disk drive, is a non-volatile storage device for storing data and instructions for use by a magnetic disk or an optical disk drive, which in turn may be used by one or more processors 710. Mass storage 730 can store the system software for implementing embodiments described herein for purposes of loading that software into memory 720.

Portable storage 740 may operate in conjunction with a portable non-volatile storage medium, such as a compact disk (CD) or digital video disc (DVD), to input and output data and code to and from the computing system 700 of FIG. 7. The system software for implementing embodiments described herein may be stored on such a portable medium and input to the computing system 700 via the portable storage 740.

One or more input devices 760 provide a portion of a user interface. The one or more input devices 760 may include an alphanumeric keypad, such as a keyboard, for inputting alphanumeric and other information, or a pointing device, such as a mouse, a trackball, a stylus, or cursor direction keys. Additionally, the computing system 700 as shown in FIG. 7 includes one or more output devices 750. Suitable one or more output devices 750 include speakers, printers, network interfaces, and monitors.

Network interface 770 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 770 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 780 may include any type of computer support device to add additional functionality to the computing system. The one or more peripheral devices 780 may include a modem or a router.

The components contained in the exemplary computing system 700 of FIG. 7 are those typically found in computing systems that may be suitable for use with embodiments described herein and are intended to represent a broad category of such computer components that are well known in the art. Thus, the exemplary computing system 700 of FIG. 7 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, systems and methods for validation and certification of digital assets using a blockchain are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for validation and certification of plurality of digital assets using a blockchain, the system comprising:
at least one processor; and
a memory communicatively coupled to the processor, the memory storing instructions executable by the at least one processor to perform a method comprising:
using a hash function to generate at least one hash of at least one digital asset, the at least one digital asset being associated with the plurality of digital assets;
storing the at least one hash to a database;
determining that the plurality of digital assets have been digitally certified by an authorized user; and
in response to the determination, storing a record on the blockchain, the record including the at least one hash of the at least one digital asset associated with the plurality of digital assets.

2. The system of claim 1, wherein the hash function includes a cryptographic hash function.

3. The system of claim 1, further comprising providing at least one further user with permission rights to read the at least one digital asset.

4. The system of claim 1, further comprising associating a digital signature and professional credentials of the authorized user with the at least one hash.

5. The system of claim 1, further comprising associating a timestamp with the at least one hash.

6. The system of claim 1, further comprising:
receiving a request to verify authenticity of the at least one digital asset;
using the hash function to hash the at least one digital asset to generate at least one further hash;
determining whether the at least one hash stored on the blockchain matches the at least one further hash; and
based on the determination, selectively verifying the authenticity of the at least one digital asset.

7. The system of claim 1, wherein the at least one digital asset is associated with a further plurality of digital assets.

8. The system of claim 1, wherein the at least one digital asset is digitally certified by more than one authorized user.

9. The system of claim 1, wherein the plurality is digitally certified by one of the following: a professional architect, a construction engineer, a land surveyor, a landscape architect, a geotechnical engineer, and an interior designer.

10. The system of claim 1, wherein the at least one digital asset includes one of the following: a building information model, an architectural plan sheet, an architectural sketch, a technical drawing, and a manufacturer cut sheet.

11. A method for validation and certification of a plurality of digital assets using a blockchain, the method comprising:
using a hash function to generate at least one hash of at least one digital asset, the at least one digital asset being associated with the plurality of digital assets;
storing the at least one hash to a database;
determining that the plurality of digital assets have been digitally certified by an authorized user; and
in response to the determination, storing a record on the blockchain, the record including the at least one hash of the at least one digital asset associated with the plurality of digital assets.

12. The method of claim 11, wherein the hash function includes a cryptographic hash function.

13. The method of claim 11, further comprising providing at least one further user with permission rights to read the at least one digital asset.

14. The method of claim 11, further comprising associating a digital signature and professional credentials of the authorized user with the at least one hash.

15. The method of claim 11, further comprising associating a timestamp with the at least one hash.

16. The method of claim 11, further comprising:
receiving a request to verify authenticity of the at least one digital asset;
using the hash function to hash the at least one digital asset to generate at least one further hash;
determining whether the at least one hash stored on the blockchain matches the at least one further hash; and
based on the determination, selectively verifying the authenticity of the at least one digital asset.

17. The method of claim 11, wherein the at least one digital asset is associated with a further plurality of digital assets.

18. The method of claim 11, wherein the at least one digital asset is digitally certified by more than one authorized user.

19. The method of claim 11, wherein the plurality is digitally certified by one of the following: a professional architect, a construction engineer, a land surveyor, a landscape architect, a geotechnical engineer, and an interior designer.

20. A non-transitory processor-readable medium having embodied thereon a program being executable by at least one processor to perform a method for plurality of digital assets using a blockchain, the method comprising:
using a hash function to generate at least one hash of at least one digital asset, the at least one digital asset being associated with the plurality of digital assets;
storing the at least one hash to a database;
determining that the plurality of digital assets have been digitally certified by an authorized user; and
in response to the determination, storing a record on the blockchain, the record including the at least one hash of the at least one digital asset associated with the plurality of digital assets.
